(19) United States
(12) Patent Application Publication
(10) Pub. No.: US 2014/0006669 A1
(43) Pub. Date: Jan. 2, 2014

(54) RETRACTABLE DEVICE DOCK

(71) Applicants: Philip A. Klein, Hilliard, OH (US); David G. Peterson, East Liberty, OH (US)

(72) Inventors: Philip A. Klein, Hilliard, OH (US); David G. Peterson, East Liberty, OH (US)

(73) Assignee: HONDA MOTOR CO., LTD., Tokyo (JP)

(21) Appl. No.: 13/537,359

(22) Filed: Jun. 29, 2012

(51) Int. Cl. G06F 13/00

(52) U.S. Cl. 710/303

(57) ABSTRACT

A built-in docking station in a vehicle for a removable portable electronic device includes a retractable element and a portable device holder. The retractable element has a first end secured to the vehicle and a second distal end movable relative to the first end and adapted to be positioned in a plurality of positions relative to the first end. The portable device holder is mounted at the second distal end of the retractable element. The portable device holder is adapted to hold an associated portable device and has at least one connector for connecting to the associated portable device that transmits at least one of power, data signals or audio signals.

### BACKGROUND

The present disclosure generally relates to vehicles, and particularly relates to a built-in retractable docking station provided in a vehicle for a removable portable electronic device.

The use of portable electronic devices has greatly increased in recent years, including the use of many varieties of smart phones, MP3 players, mobile cell phones, navigation devices, etc. Additionally, there is an increasing demand by vehicle customers to be able to use their portable electronic devices in conjunction with their vehicles. For example, there is a recognized demand by consumers for the ability to easily and conveniently play music from portable electronic devices through a vehicle's sound or entertainment system. There is also a desire to have smart phones connected to the vehicle to enable hands-free operation of the phone. Further, there is a desire to generally charge a wide variety of portable electronic devices with power from the vehicle. It is expected that these demands will only increase as customers will continue on an increasing frequency to want to use their portable electronic devices in their vehicles and have their portable electronic devices connect with their vehicles for exchange of data and/or powering of the portable electronic device.

There are presently several types of docking stations available in the marketplace to be used in vehicles for connecting portable electronic devices to the vehicle. Some of these docking stations attempt to provide universal functionality such that the docking station can be used with a wider variety of portable electronic devices provided by a wide variety of manufacturers. Most of these docking stations are provided as accessories for use in association with the portable electronic device. In other words, the docking station is sold as an accessory to the portable device and not integrated into the design of the vehicle. Typically customers purchase these docking stations and the customer installs the docking station inside the vehicle himself or herself.

It is known that customers want a specific, customizable and usable place for their portable electronic devices in vehicles. Many portable electronic devices used in vehicles have a plurality of connectors, such as a power connector, an audio input connector, and/or a USB connector/port. Unfortunately, however, conventional vehicle layouts do not always provide the necessary connections for the portable device. Moreover, even when provided in the vehicle, the connectors are usually not ideal for the placement of the portable electronic device. For example, a power connector and an audio connector might both be provided in a vehicle but are not located together at a single location. As a result, vehicle layouts often limit the customer as to where he or she can position and use his or her portable electronic device in the vehicle. Additionally, after-market docking stations can sometimes be problematic because such docking stations may block the driver's visibility.

### SUMMARY

According to one aspect, a built-in docking station in a vehicle for a removable portable electronic device includes a retractable element and a portable device holder. The retractable element has a first end secured to the vehicle and a second distal end movable relative to the first end and adapted to be positioned in a plurality of positions relative to the first end. The portable device holder is mounted at the second distal end of the retractable element. The portable device holder is adapted to hold an associated portable device and has at least one connector for connecting to the associated portable device that transmits at least one of power, data signals or audio signals.

According to another aspect, a vehicle docking station includes a support arm having a first end fixed inside a vehicle and a second end. The vehicle docking station further includes a portable device holder mounted to the second end of the support arm, and connectors for connecting to an associated portable electronic device held by the portable device holder. The connectors including at least two of: a power jack, an audio input jack, and a USB port.

According to a further aspect, an integrated vehicle docking station for accommodating a variety of portable electronic devices includes a holder for carrying a portable electronic device in a vehicle and a retractable support arm having a first end fixed to the vehicle and a second end suspending the holder within a passenger compartment of the vehicle. The docking station further includes a plurality of connectors on the holder for connecting the vehicle to the portable electronic device.

### BRIEF DESCRIPTION OF THE DRAWINGS

FIG. 1 is a partial schematic view of the inside of a vehicle showing a built-in docking station in a retracted state within an overhead console of the vehicle.

FIG. 2 is another partial perspective view of the inside of a vehicle, similar to FIG. 1, but showing the built-in docking station in an expanded state and holding a portable electronic device.

FIG. 3 is a front elevational view of a portable device holder of the built-in docking station shown holding the portable electronic device and having connectors connected to the portable electronic device.

FIG. 3A is a cross-sectional view taken through the one of the rod members supporting the docking station in the expanded state.

FIG. 4 is a partial cross-sectional view taken along the line 4-4 of FIG. 3 showing a sliding member of the device holder securing the portable electronic device.

FIG. 5 is another front elevational view of the portable device holder shown with the portable electronic device removed.

FIG. 6 is a side elevational view of the portable device holder.

FIG. 7 is a rear elevational view of the portable device holder.

### DETAILED DESCRIPTION

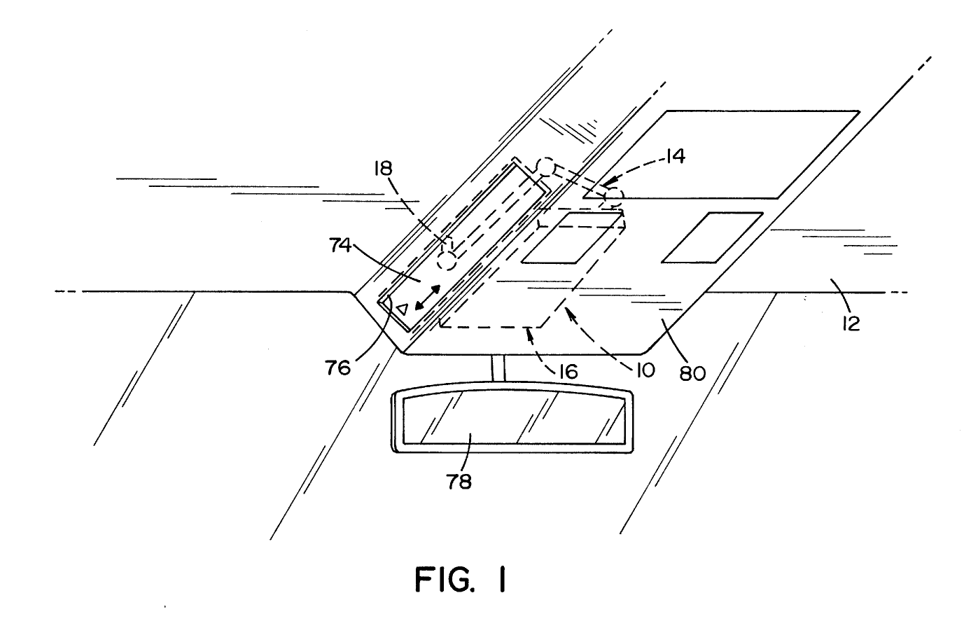

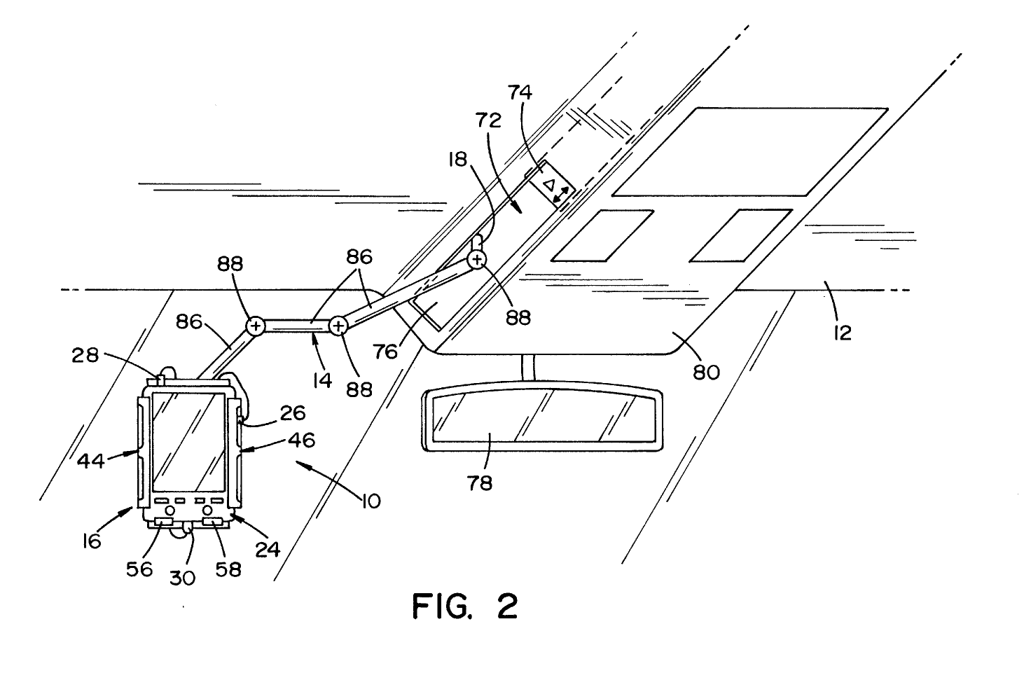

Referring now to the drawings wherein the showings are only for purposes of illustrating one or more exemplary embodiments and not for purposes of limiting the same, FIGS. 1 and 2 illustrate a built-in docking station 10 provided in a vehicle 12 for a removable portable electronic device. The docking station 10, which can also be referred to as a retractable dock or an integrated vehicle docking station, is provided for accommodating a variety of electronic devices, including those having varying sizes and shapes and/or those having varying connectors for connecting to the vehicle 12 to send or receive data, to send or receive audio signals and/or to receive power from the vehicle 12 (e.g., for charging the portable device). The docking station 10 includes a retractable support arm or element 14 and a portable device holder 16.

As will be described in more detail below, the retractable arm or element 14 has a first end 18 secured or affixed to the vehicle 12 on an inside of the vehicle 12. The retractable arm or element 14 also has a second end 20 that is distal relative to the first end 18 and is movable relative to the first end 18. More particularly, the second distal end 20 is adapted to be positioned in a plurality of positions relative to the first end 18 (e.g., the position illustrated in FIG. 2) for suspending the holder 16 within a passenger compartment of the vehicle 12. As shown, the portable device holder 16 is mounted to or at the second distal end 20 of the retractable arm or element 14 for carrying a portable electronic device (e.g., illustrated portable electronic device 24) in the vehicle 12.

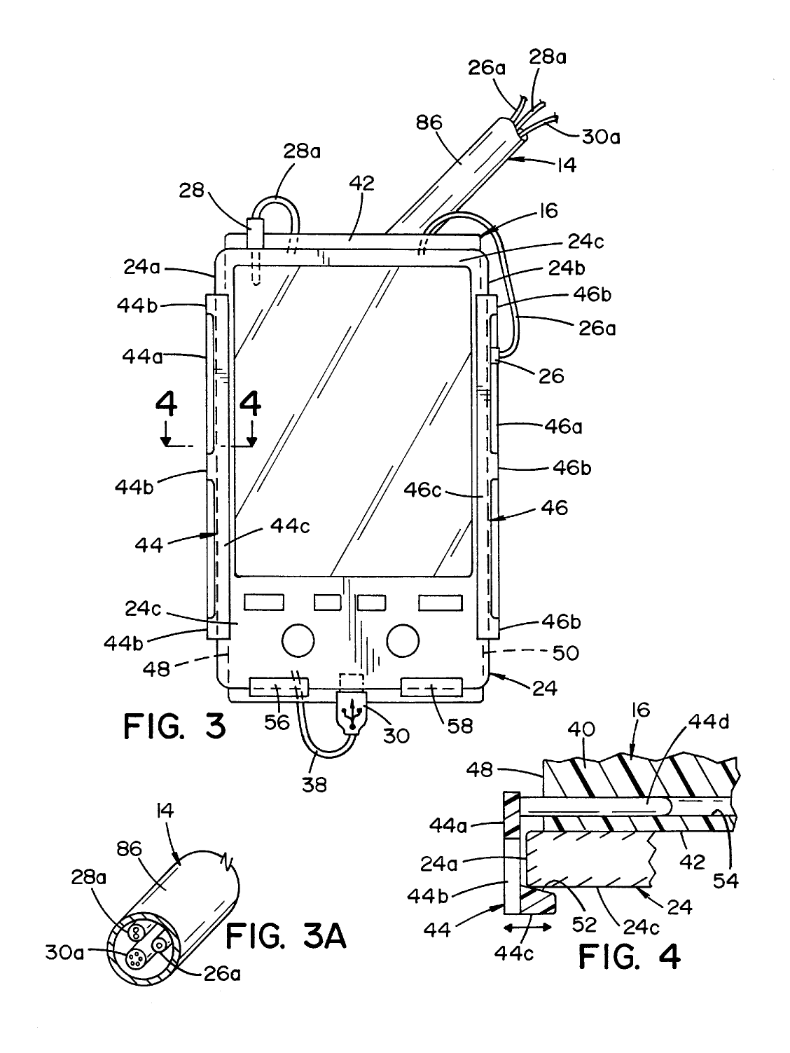

More particularly, the portable device holder 16 is adapted to hold an associated portable device, such as illustrated device 24, and has at least one connector for connecting to the portable device 24 that transmits at least one of power, data signals, or audio signals with the vehicle 12. In the illustrated embodiment, and with additional reference to FIG. 3, the docking station 10 includes a plurality of connectors 26, 28, 30 disposed on the holder 16 for connecting the vehicle 12 to the portable electronic device 24 held by the holder 16. More generally, in one embodiment, the connectors include at least two of: a power jack, an audio input jack and a USB port. In the illustrated embodiment, as will be described in more detail below, the connectors 26, 28, 30 include all three of a power jack, and audio input jack and a USB port.

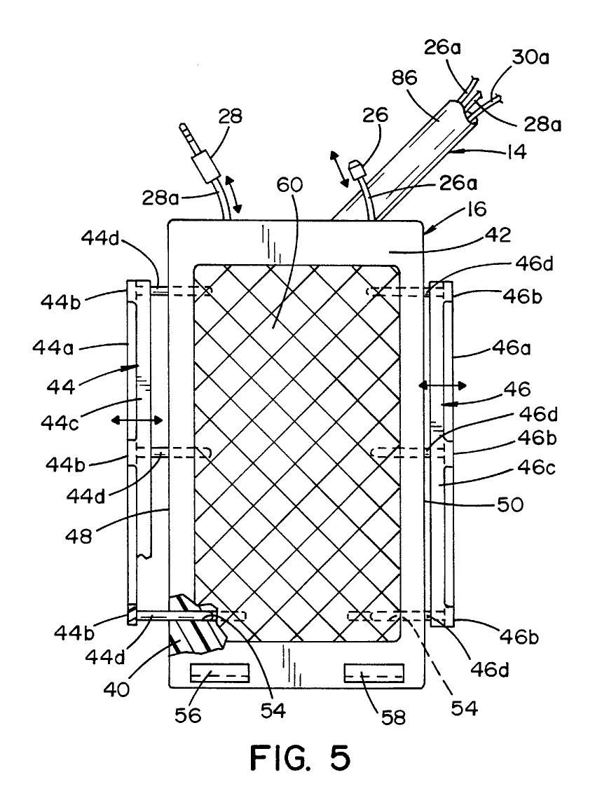

More specifically, and with further reference to FIGS. 5-7, the portable device holder 16 can include the connector 26 as a power connector for supplying power from the vehicle 12 to the portable device 24 (e.g., from the primary battery of the vehicle 12). As shown in the illustrated embodiment, the power connector 26 can be a power pigtail harness. Optionally, and as will be described in further detail below, the power connector 26 can be used with an adaptor tip for accommodating a variety of portable electronic devices having varying types of power input ports. As shown, the connector 28 can be an audio input connector for transmitting audio signals from the portable device 24 to the vehicle 12. Like the power connector 26, the illustrated audio input connector 28 can be an audio input pigtail harness and can optionally be used with an adapter tip for accommodating a variety of portable electronic devices having varying types of audio out ports (e.g., 2.5 mm and 3.5 mm headphone jacks).

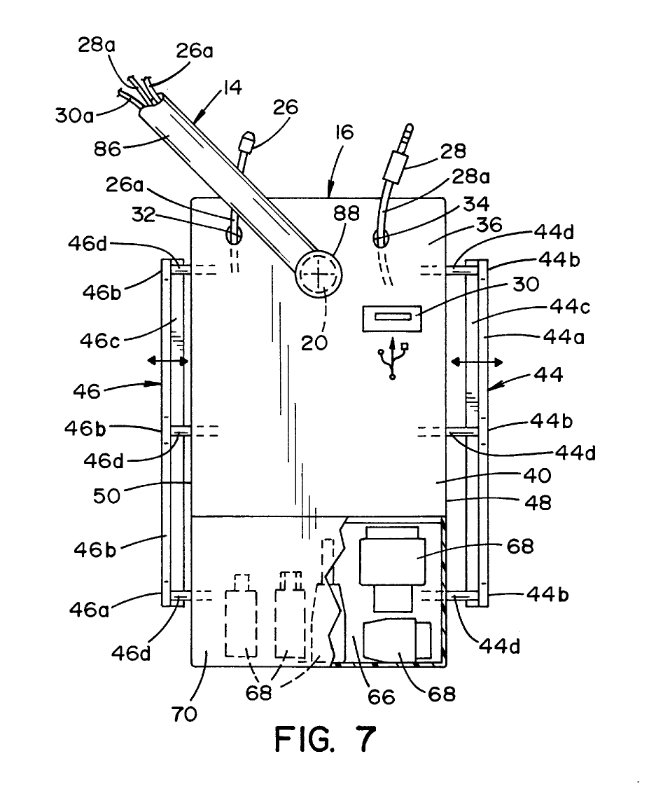

With particular reference to FIG. 7, the connectors 26, 28 of the illustrated embodiment extend through apertures 32, 34 in a rear side 36 of the holder 16 and have wires or cords 26a, 28a for allowing flexibility in the connector 26 and/or 28 reaching the corresponding connector port on the portable electronic device 24. As shown by the arrows in FIG. 5, the cords 26a, 28b can be retracted into and extended from the apertures 32, 34 of the holder 16 to allow the respective lengths of the cords 26a, 28a to be increased or decreased as desired. This facilitates the cords 26a, 28a reaching corresponding ports on the portable electronic device 24 wherever located and allows excess cord length to be retracted or withdrawn within the holder 16, which improves aesthetics of the docking station 10.

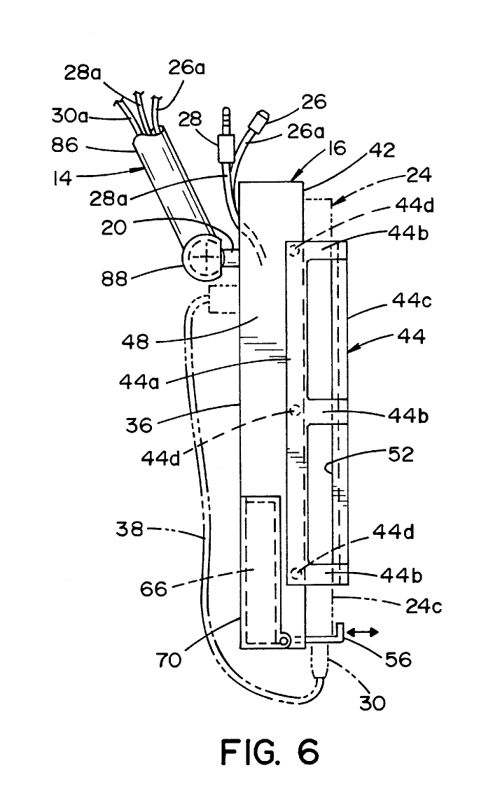

The portable device holder 10 can further include the connector 30 as a USB port for connecting the associated portable device 24 to the vehicle 12 via USB protocols. In the illustrated embodiment, the USB connector or port 30 is disposed on the rear side 36 of the device adjacent and below the aperture 34. In this case, and as best shown in FIGS. 3 and 6, a USB cord 38 can plug into the USB port 30 and also plug into the portable device 24 wherever the corresponding USB port is located on the portable device 24 as is known and understood by those skilled in the art. Alternatively, the USB cord 38 could be integrated with the portable device or integrated with the device holder 16. As mentioned, the portable device holder 16 can, in one embodiment, include at least two of the power connector 26, the audio connector 28 and the USB port 30, but in the illustrated embodiment includes all of the connectors 26, 28 and 30.

The portable device holder 16 includes a base 40 against which the portable device 24 can be secured. In particular, the portable device 24 is secured against a front surface 42 of the base 40, the surface 36 forming an opposite or rear side of the base 40. The portable device holder 16 further includes at least one movable member for securing the portable device 24 to the holder 16. More specifically, in the illustrated embodiment, the at least one movable member includes or is a pair of sliding members 44, 46 provided on lateral sides 48, 50 of the base 40. Each of the sliding members 44, 46 is laterally slidable such that the portable device 24 is able to be clamped between the sliding members 44, 46.

More specifically, each sliding member 44, 46 can include a base portion 44a, 46a and one or more engaging portions 44b, 46b extending upward from the respective base portions 44a, 46a. The engaging portions 44b, 46b (three in the illustrated embodiment, but any number could be used) engage the lateral sides 24a, 24b of the portable device 24. The sliding members 44, 46 can further include upper portions 44c, 46c for engaging an upper face 24c of the portable device 24. As best shown with respect to the sliding member 44 in FIG. 4, the upper portions 44c, 46c can each include a tapered contact surface (e.g., tapered contact surface 52 on upper portion 44c) for particularly engaging the portable device 24 and the upper surface 24c thereof adjacent the peripheral edges of the upper surface 24c.

As shown, the sliding members 44, 46 can additionally include respective sliding rods 44d, 46d that enable the sliding members 44, 46 to be respectively slid laterally as shown by the arrows in FIGS. 5 and 7. In operation, the slide members 44, 46 can be slid to wide open positions (e.g., as shown in FIGS. 5 and 7) and a portable device 24 installed in the docking station 10 against the base 40 of the device holder 16. Once installed, the sliding members 44, 46 can be moved toward one another to converge on the portable device 24 and secure the same to the device holder 16 (e.g., as shown in FIG. 3). In particular, the sliding rods 44d, 46d can be received within corresponding apertures 54 defined in the device holder 16, and particularly the base 40 thereof. Though a wide variety of configurations can be used, in one embodiment the sliding rods 44d, 46d have a friction fit relative to the apertures 54 enabling movement of the sliding members 44, 46 to desired positions but once so moved the sliding members 44, 46 generally remain in position.

A pair of L-shaped bracket members 56, 58 can be provided adjacent a lower end of the base 40 on the forward surface 42 of the base 40. The L-shaped brackets 56, 58 can carry the portable device 24 or hold and support the portable device 24 on the holder 16. In conjunction with the sliding members 44, 46, the brackets 56, 58 secure the portable device 24 in a secured manner to the base 40 of the device holder 16. In the illustrated embodiment, the brackets 56, 58 are slidable into and away from the forward surface 42 to accommodate portable devices 24 of varying thicknesses. Optionally, as shown in FIG. 5, a power/charging mat 60 can be integrated into the forward surface 42 of the base 40 for powering the portable device 24 inductively as will be known and understood by those skilled in the art.

Optionally, the portable device holder 16 can include a storage area 66 for carrying a plurality of adapters 68, the adapters 68 for securing or facilitating connection of one or more of the connectors 26, 28, 30 of the portable device holder 16 and the portable device 24. The adapters 68 can be those that are generally known in the art and enable the connectors 26, 28 and/or 30 to connect to varying connectors of varying portable devices. As shown in the illustrated embodiment in FIGS. 6 and 7, the storage compartment 66 can be accessible via a movable closure 70 disposed on the portable device holder 16. More particularly, the movable closure 70 can be a portion of the base 40 pivotally connected and selectively openable for accessing the storage area to retrieve or return one of the adapters 68.

With specific reference to FIGS. 1 and 2, the first end 18 of the retractable arm or element 14 is received in a storage compartment 72 defined in the vehicle 12 in the illustrated embodiment. In particular, the retractable arm or element 14 is foldable into a compact state (FIG. 1) wherein the retractable arm or element 14 and the device holder 16 can fit inside the storage compartment 72. The retractable arm or element 14 can be unfolded into an extended state (FIG. 2) wherein the retractable arm or element 14 can be used to position the device holder 16 or locate the device holder 16 in one of the plurality of positions, which can include positions spaced apart from the storage compartment 72 and suspended within the passenger compartment of the vehicle 12.

As shown, a sliding closure 74 can be disposed over an opening 76 of the storage compartment 72 for providing selective access to the storage compartment 72. The sliding closure 74 is movable between a closed position (shown in FIG. 1) wherein the sliding closure 74 conceals the retractable arm or element 14 and the portable device holder 16 within the storage compartment 72, and an open position wherein access to the storage compartment 72 is provided to allow for unfolding of the retractable arm or element 14 from the storage compartment 72 or folding of the retractable arm or element 14 into the storage compartment 72. As shown in the illustrated embodiment, the storage compartment 72 can be defined in a roof console 80 of the vehicle 12 and thus the retractable device dock 10 is located on the roof of the vehicle 12, though this is not required. In particular, the storage compartment 72 and the sliding closure 74 can be located in the roof console 80 on a driver's side thereof (i.e., facing the driver seat area of the vehicle 12).

When retracted into the storage compartment 72 with the sliding closure 74 in the closed position, the roof console 80 has a good appearance and generally conceals the built-in docking station 10. When removed from the storage compartment 72, the docking station 10, and particularly the device holder 16 secured by the retractable arm or element 14 can be moved to one of a plurality of positions, including a plurality of positions adjacent a rearview mirror 78 of the vehicle 12. This is advantageous in that a position located adjacent the rearview mirror 78 is generally considered a relatively safe and usable location for drivers of the vehicle 12 because this provides an optimal view of a portable electronic device 24 carried by the holder 16 while keeping clear of the rearview mirror 78.

Additionally adding to usability and convenience of the docking station 10, the retractable arm or element 14 can comprise a plurality of rod members 86 and a plurality of ball joint connections 88 interconnecting the rod members 86 and the portable device holder 16. Optionally, the ends 18, 20 of the retractable element 14 can be truncated rod members (i.e., like the rod members 86 but shorter). The ball joint connections 88 allow greater flexibility in positioning of the portable device holder 16 and therefore the portable device 24 held by the holder 16 within the vehicle 12. The ball joint connections 88 can be friction type ball joint connections that generally are movable about 360 degrees but hold their position once set. This configuration (i.e., rod members and ball joints) allows for the retractable element 14 to be easily folded into its collapsed state shown in FIG. 1 and later unfolded into its extended state shown in FIG. 2. The wires 26a, 28a and 30a (or other electrically connected wires) for electrically connecting the connectors 26, 28, 30 can be routed from the device holder base 40 to the various systems and/or components of the vehicle 12 through the rod members 86 (see FIG. 3A) and connections 88, as will be appreciated and understood by those skilled in art. For example, the connector 26 can be connected to the vehicle's power system. Likewise, the connectors 26, 28 can be connected to the vehicle's sound system, infotainment system or the like.

Advantageously, as described herein, the built-in docking station 10 provides integrated harness management that can support power, audio input and USB communications for electronic media devices (e.g., portable device 24) such as MP3 players, mobile cell phones, navigation devices, etc. An advantage of the docking station 10 is that it provides customers an optimal place to store and use their portable electronic devices while supplying power, an audio input jack, and a USB port together at a single, convenient location. Also advantageous, the docking station 10 can support old and new electrical devices through its incorporated features. Additional advantages include that the docking station 10 provides a specified retractable, customizable, and universal docking station, reduces driver distractions through integrated harness management, makes electrical devices more usable and safer to operate in a vehicle, and provides power, audio input jack, and USB port together at a single convenient location.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A built-in docking station in a vehicle for a removable portable electronic device, comprising:
a retractable element having a first end secured to the vehicle and a second distal end movable relative to the first end and adapted to be positioned in a plurality of positions relative to the first end; and
a portable device holder mounted at the second distal end of the retractable element, the portable device holder adapted to hold an associated portable device and having at least one connector for connecting to the associated portable device to transmits at least one of power, data signals or audio signals.

2. The built-in docking station of claim 1 wherein the portable device holder includes a power connector for supplying power from the vehicle to the portable device.

3. The built-in docking station of claim 1 wherein the portable device holder includes an audio input connector for transmitting audio signals from the associated portable device to the vehicle.

4. The built-in docking station of claim 1 wherein the portable device holder includes a USB port for connecting the associated portable device to the vehicle via USB protocol.

5. The built-in docking station of claim 1 wherein the portable device holder includes at least two of a power connector for supplying power from the vehicle to the portable device, an audio input connector for transmitting audio signals from the associated portable device to the vehicle, and a USB port for connecting the associated portable device to the vehicle via USB protocol.

6. The built-in docking station of claim 5 wherein the portable device holder includes each of a power connector for supplying power from the vehicle to the portable device, an audio input connector for transmitting audio signals from the associated portable device to the vehicle, and a USB port for connecting the associated portable device to the vehicle via USB protocol.

7. The built-in docking station of claim 1 wherein the portable device holder includes a base against which the associated portable device is secured.

8. The built-in docking station of claim 7 wherein the base includes a power/charging mat for powering the associated portable device inductively.

9. The built-in docking station of claim 7 where the portable device holder includes at least one movable member for securing the associated portable device to the portable device holder.

10. The built-in docking station of claim 9 wherein the at least one movable member includes a pair of sliding members provided on lateral sides of the base, each of the sliding members laterally slidable such that the associated portable device is able to be clamped between the pair of sliding members.

11. The built-in docking station of claim 10 wherein a bracket member is disposed along a lower side of the base for carrying the associated portable device.

12. The built-in docking station of claim 1 wherein the portable device holder includes a storage area carrying a plurality of adapters for securing the connector of the portable device holder to the associated portable device.

13. The built-in docking station of claim 1 wherein the first end of the retractable element is received in a storage compartment defined in the vehicle, the retractable element foldable into a compact state wherein the retractable element and the portable device holder fit inside the storage compartment, the retractable element unfolded into a extended state to locate the portable device holder in one of the plurality of positions, which is spaced apart from the storage compartment.

14. The built-in docking station of claim 13 wherein a sliding closure is disposed over an opening providing access to the storage compartment, the sliding closure movable between a closed position wherein the sliding closure conceals the retractable element and the portable device holder within the storage compartment and an open position wherein access to the storage compartment is provided to allow unfolding of the retractable element from the storage compartment or folding of the retractable element into the storage compartment.

15. The built-in docking station of claim 13 wherein the storage compartment is defined in a roof console of the vehicle and one of the plurality of positions is adjacent a rearview mirror of the vehicle.

16. The built-in docking station of claim 1 wherein the retractable element includes a plurality of rod members and a plurality of ball joint connections interconnecting the rod members and the portable device holder.

17. A vehicle docking station, comprising:
a support arm having a first end fixed inside a vehicle and a second end;
a portable device holder mounted to the second end of the support arm; and
connectors for connecting to an associated portable electronic device held by the portable device holder, the connectors including at least two of: a power jack, an audio input jack and a USB port.

18. The vehicle docking station of claim 17 wherein the connectors include each of a power jack, an audio input jack and a USB port.

19. The vehicle docking station of claim 17 wherein the portable device holder includes a storage compartment accommodating a plurality of adapters for facilitating connection between the portable device holder and the associated portable electronic device, the storage compartment accessible via a movable closure disposed on the portable device holder.

20. An integrated vehicle docking station for accommodating a variety of portable electronic devices, comprising:
a holder for carrying a portable electronic device in a vehicle;
a retractable support arm having a first end fixed to the vehicle and a second end suspending the holder within a passenger compartment of the vehicle; and
a plurality of connectors on the holder for connecting the vehicle to the portable electronic device.
